(19) United States
(12) Patent Application Publication
(10) Pub. No.: US 2003/0065803 A1
(43) Pub. Date: Apr. 3, 2003

(54) Intelligent delivery method for streamed content

(75) Inventor: Jeroen Heuvelman, Campbell, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N. V.

(21) Appl. No.: 09/967,455

(22) Filed: Sep. 28, 2001

(51) Int. Cl. G06F 15/16

(52) U.S. Cl. 709/231; 709/233

(57) ABSTRACT

An end device has certain processing capabilities and an end-user has specific requirements for a streamed data stream from a service provider over a network link or from a home server. A method, system and system is provided that communicates capabilities and requirements of an end-user to the provider. This allows the service provider or home server to send a tailor made data stream. In the event that the end-user owns a wireless IHDN the method includes taking into account capabilities in a dynamical fashion.

### FIELD OF THE INVENTION

This invention relates to an optimized method of AV-content (Audio Video content) delivery from a content provider or source to an end-user. The method is in particular optimized for bandwidth usage and for storage and takes into account, when possible and available, static and dynamic characteristics of a user's profile, of the user's presentation device and of the network.

### BACKGROUND ART

In an end-to-end streamed Audio-Video (AV) content distribution system the content provider has little to no knowledge of the end-user's storage and of the I/O capabilities of the user's rendering device. In order to optimize bandwidth or storage capacity the AV content is sent in a compressed format, e.g., MPEG2 or MPEG4, from the content provider to the user. If any optimization is done at all it is typically done in a static manner, typically at the setup and start of the content's distribution. Video quality optimization at a display is typically done, if at all, after decompression of video. Audio quality optimization in a configuration with a loudspeaker is typically done, if at all, after decompression of the audio.

In a setup where the user has a wireless In Home Digital Network (IHDN) no solutions are offered that deal with external interference (see, e.g., an article published by the WSJ, Aug. 23, 2001: ‘Sony's new airboard device combines TV-set, Internet). Moreover a behavior of external interference typically changes over time as content provider usually starts a content delivery according to then present conditions.

### SUMMARY

The invention provides a method, software and control device that leverages on relevant information available on a data network for transport of a content that is streamed. This can include information on static and dynamic properties and behavior of the network. It also can include information on an end-user's profile. Moreover it can include information on an end-user's presentation or rendering means, including capabilities and properties of physical devices such as destination devices like a display monitor and a speaker.

Another aspect of the invention relates to a method that enables an efficient and reliable content delivery in a content delivery system. An optimized presentation of the content on a presentation device can, e.g., be achieved by a destination based processing. An as high as possible compression of the content can be negotiated between the source and destination. The processing on the presentation device can be optimized using knowledge of one or more aspects, such as, but not limited to:

the presentation device (processing or rendering capabilities of),

the compression applied (algorithms available on a technology),

the user profile (based on preferences, history etc.),

static behavior and properties of a transport link, and

dynamic behavior and properties of the transport link, obtained by, e.g., monitoring a condition.

When determining what bit-rate for the streamed AV-content to apply also other aspects can be taken into account. Take as example a Wireless Internet Appliance (WIA, such as a WebPad device), which is able to display streamed video directly on its screen. The WIA typically receives the AV-content over a wireless IHDN. This wireless network is probably the weakest link in the end-to-end distribution system in terms Quality of Service (QoS: comprising parameters such as guaranteed bandwidth, transmission error measures, latency and jitter).Therefore another aspect of the invention relates to a system and a method that can make an estimation of a guaranteed bandwidth at a certain predefined reliability. The guaranteed bandwidth, taking into account the complete delivery chain, can be used for data communication between the content provider and the final destination. But it is also envisioned that certain parts of the delivery chain, such as between two nodes of a wireless IHDN, determine the guaranteed bandwidth. This can be for that part of the chain only or for a bigger part. Dynamical properties of the link (in particular in case of a wireless link) can be taken into account as well, as detailed later.

A further aspect of the invention relates to a method that addresses network problems such as streamed content packet loss (e.g., due to transmission errors) and of an over time varying bandwidth available for a streaming session. It is in many cases possible, at the moment of setting-up a connection, to determine guaranteed bandwidth available for streaming content. In wired-link based standards, such as based on IEEE1394-1995 and UPnP, this is typically supported by the protocol. In such standards a bus-master typically keeps track of available bandwidth, typically isynchronous and/or asynchronous, and can allocate guaranteed bandwidth. In wireless environments though there is no such thing as guaranteed bandwidth since circumstances beyond control can change. First of all, wireless networks can have some overlap. For instance a user's neighbor can be using a same or different type of wireless network that operates in a same or overlapping part of an allocated spectrum (from here onwards referred to as band). Examples of the spectrum in this context are a Radio Frequency (RF) spectrum, an InfraRed (IR) spectrum, and a sonar spectrum. Secondly, other interference sources can exist such as a microwave oven, which can radiate into a 2.4 GHz RF band that is allocated to an IEEE802.11b standard (802.11b). Thirdly, the wireless signal for the intended transmission can suffer from substantial degradation due to factors such as too long distance between transmitter and receiver or due to physical obstacles between a transmitter and a receiver, etc.

Another aspect of the invention relates to a method that enables the streaming at a lowest possible bit-rate by communicating, e.g., information about backend processing and storage capabilities. For example, a Set-Top-Box (STB: in this context a cable or satellite or terrestrial digital CE-receiver) comprising a Personal TeleVision feature (PTV: a user friendly digital VCR based on hard disk drive technology) can request the content provider to limit the size of the desired content, e.g., the movie ‘Never-ending story’ or a segment thereof. For instance the STB may only have 2 GB of storage space left on its internal HDD and therefore may request to limit the size ‘Never-ending story’ to 2 GB instead of the usual size, e.g. 3 GB. By enabling the streaming at the lowest possible streaming bit-rate, this provides, e.g., a lowest link usage and thus cost as well as lower storage requirements.

### BRIEF DESCRIPTION OF THE DRAWINGS

The invention is explained by way of example and with reference to the accompanying drawings, wherein:

FIG. 1 is a functional block diagram of an in home wireless digital network.

FIG. 2 is a functional block diagram of an end-to-end delivery system of the invention.

### DETAILED DESCRIPTION

Preferred embodiments of the present invention will be described herein below with reference to the accompanying drawings. In the following description, well-known functions or constructions are not described in detail since they would obscure the invention in unnecessary detail.

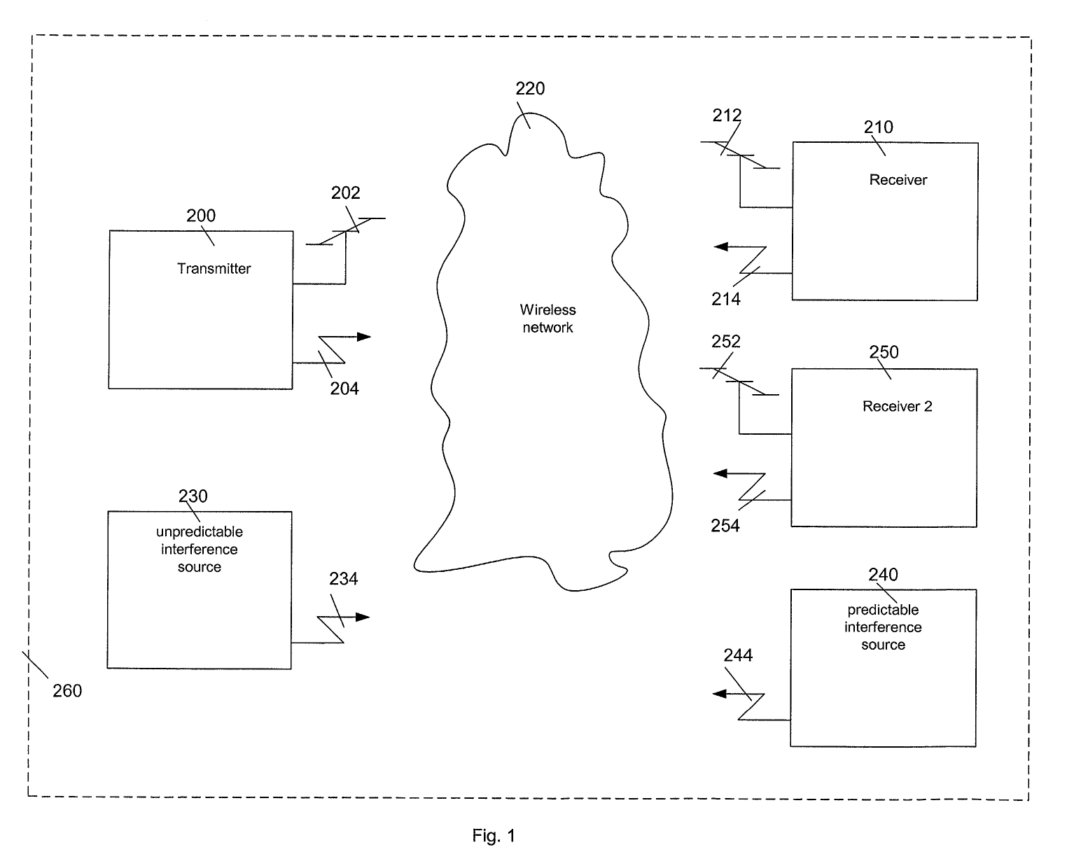

FIG. 1 comprises a functional block diagram of a wireless IHDN system and environment 260. System and environment 260 comprise a wireless transmitter 200, a wireless receiver 210, a second wireless receiver 250, an unpredictable interference source 230, a predictable interference source 240 and a wireless network 220. In a typical, but not exclusive, embodiment wireless network 220 comprises, e.g., a wireless link between two rooms in a home. A connection between the transmitter 200 and the receiver 210 does not necessarily need to be a direct line-of-sight one. Radio waves, such as based on the 802.11b standard, can penetrate, to a certain extent, through objects such as a wall separating two adjacent rooms. Moreover, transmitted radio waves can be reflected by, e.g., objects, but still reach their intended destination, although slightly delayed (due to the longer path the waves traveled).

Transmitter 200 comprises a wireless receiver 202 and a wireless transmitter 204. Transmitter 200 will typically need the receiver 202, e.g., to be able to receive an acknowledgement from receiver 210 to signal a successful transmission of a transmitted data package (i.e., receiver 210 has received the package without an error). It is possible to have the receiver and transmitter physically combined into one device. In a typical, but not exclusive, embodiment transmitter 200 comprises, e.g., a consumer STB such as a Personal Video Recorder that is capable of outputting previously recorded AV content over the wireless network 220. In another embodiment the consumer STB is capable of outputting previously recorded AV content or currently airing AV content after some pre-processing has been done for reasons explained below.

Receiver 210 comprises a wireless receiver 212 and a wireless transmitter 214. As explained before, transmitter 212 of receiver 210 can, e.g., be used to send an acknowledgement after a received data package. In a typical, but not exclusive, embodiment receiver 210 comprises, e.g., an AV presentation device such as an High Definition Television (HDTV) that is capable of receiving streamed AV content over the wireless medium link 220. An example of a system that includes transmitter 200 in combination with receiver 210 is a wireless IHDN, e.g., one based on the 802.11b standard. In a typical, but not exclusive, embodiment the system can be used to distribute streamed AV content from a receiving STB to a display with speaker system within the home in a wireless fashion.

Receiver 250 comprises a wireless receiver 252 and a wireless transmitter 254.

Unpredictable interference source 230 comprises an interference transmitter 234. An example of source 230 in a medium link 220 that can make use of a 2.4 GHz RF band is, e.g., a microwave oven. A microwave oven typically generates RF waves using an oscillator that can have, e.g., a temperature drift in its frequency. Certain standardized wireless protocols such as based on the 802.11b standard make use of the 2.4 GHz RF band as well. These protocols are susceptible to microwave radiation and the quality of the data communicated can degrade as a result. Microwave ovens typically produce RF waves at or around 2.4 GHz in operational use, a certain percentage of which leaks away. The RF waves of the oven can at a certain time occupy a part of the RF band that is also being used by the system based on the 802.11b standard. Moments later though this can change due to the aforementioned drift.

Source 230 and other unpredictable random interference sources can be modeled by the transmitter 200 and/or receiver 210. One way is to model a source such as the microwave oven as a random noise generator. Another model, that has turned out to be valuable in case of the microwave oven, is to regard the source as one that temporarily uses a certain sub-band in the RF band. An allocated spectrum or band for a wireless protocol, such as based on the 802.11b standard, is typically sub divided into one or more sub-bands. The protocol can typically simultaneously make use of one or more of the sub-bands. Transmitter 200 and/or receiver 210 can measure a reliability aspect of the wireless network 220 by, e.g., sending each other test data packages (e.g., by pinging, a technique known from the internet). This can be done on a regular basis and for any of the RF sub-bands in the RF band. This enables a control device to monitor certain quality aspects, to monitor an availability of a sub-band (e.g., monitor whether the sub-band in use and if not does any interference take place) and to monitor other aspects. Quality aspects of the RF sub-bands of the network 220, such as the error rate in a transport or the signal-to-noise ratio, can be measured by using the transmitter 200 and/or receiver 210. Typically a RF sub-band with a better than average quality rating will preferably be used for, e.g., a video streaming session. Walls and other objects that obstruct a direct view between transmitter 200 and receiver 210, can impact the quality aspects.

Depending on, e.g., the quality aspects and the modeling of the unpredictable interference source countermeasures can be taken. These countermeasures can include, but are not limited to,

applying a more stronger and/or sophisticated error correction method

transmitting a data packet (a streamed content typically, but not exclusively, comprises a multiple of relative small data packets) over more then one RF sub-band (e.g., by frequency hopping or by using spread spectrum technology)

multiple transmissions of a data package, possibly time and/or frequency multiplexed.

buffering the content at the receiver 210 in order to have some time to take an counter action, e.g., when a multiple of errors occurs (possibly in combination with a, faster than real-time, burst capability).

These countermeasures may require certain provisions such as a larger buffer and processing means in the transmitter 200 and/or receiver 210.

The predictable interference source 240 comprises an interference transmitter 244. An example of source 240 is a transmitter that makes use of a same band and protocol as transmitter 200 does, e.g., another one based on the 802.11b standard as in the example before. The usage of the same band by another device is possible, e.g., when another user, such as a neighbor, uses a similar wireless device.

The invention discloses a way to cope with predictable interference. One way is to eavesdrop, on a regular basis, on various RF sub-bands of which the transmitter and receiver can make use. By doing so the transmitter and/or receiver are able to make predictions of the usage of the RF sub-bands in the RF band and claim one or more reliable RF sub-bands according to its needs. The inventor proposes a protocol extension that enables a wireless IHDN to negotiate a bandwidth (e.g., comprising one or more sub-bands) with a similar wireless IHDN that are in its proximity. Such a protocol extension needs to be implemented within the protocol, such as one based on the 802.11b standard. The protocol extension should be developed taking into account a future standard that makes use of the same RF band by, e.g., allowing a simple extension.

Using techniques and methods as described in the previous sections a transmitter 200 and receiver 210 combination is able to deduct at what maximum bit-rate it can stream content in a reliable fashion. It can do so even in a dynamical fashion, providing it monitors the wireless network as described earlier. This allows the combination to make use of a reliable stream of data that can vary in transmission bit-rate. The advantage of this will be explained in the example of next paragraph.

Assume that the user wants to view an HDTV formatted movie on receiver 210. This movie is, e.g., stored on a hard disk drive within transmitter 200. This movie has been recorded earlier with a bit-rate of 10 Mbs. In conditions of only moderate interference from source 230 and source 240 the receiver 210 is able to receive a data stream from transmitter 200 with a bit-rate bigger than 10 Mbs. The combination continuously monitors the wireless network and finds that a maximum reliable transmission bit-rate of only 5 Mbs is available at the moment that the user requests a playback of the movie. When the transmitter of this example has a means to output the data (in this example the HDTV formatted movie) at a lower bit-rate it will offer the movie at a 5 Mbs bit-rate (obviously at a somewhat reduced quality level). An audio-video-compression scheme that allows transmission and/or storage of AV content with a scalable bitrate (and thus quality) is recommended for this purpose (e.g., MPEG4 and Motion JPEG2000 enable this). At the latest at the moment of initialization of the transmission, the transmitter must have some knowledge of the capabilities of the receiver. This may include knowledge on a device processing capability (e.g., which encoding standard is supported) and receiver's storage capability (e.g., for allowing some video buffering in case a retransmission of a video package is required). A re-encoding (also called transcoding) scheme may also be used to convert the 10 Mbs bitrate to the 5 Mbs but this usually requires a hard and/or software provision in, at least, the transmitter 200. When, at a later stage of watching the movie over the wireless network, a reliable bit-rate of 10 Mbs is available the combination will switch the wireless transmission to the full 10 Mbs. But in the event the end-user (e.g., a child family member) is not interested in the seeing the movie in high resolution the receiver decide to transmit to movie at a reduced bit-rate in order to save resources for other tasks. Obviously, an end-user's interest or profile needs to be communicated to transmitter 200.

In yet another example a second receiver 250 has only a limited screen size. An example of receiver 250 is a PDA that is able to display streamed video over the wireless network 220. As transmitter can have the content store in a much higher resolution, as the movie of the previous example with a bit-rate of 10 Mbs with, e.g., a 1920×1024 pixels spatial resolution. The PDA will communicate its screen size, e.g., 320×240 pixels, to transmitter 200, e.g., a home server. When the end-user requests a playback of the HDTV movie on the PDA, home server will transmit the movie over wireless network 220 at a reduced resolution of, e.g., 320×240 pixels. The bit-rate for the movie at the reduced resolution that is needed for the transmission will now be in the order of magnitude of 400 kbps. The previous therefore clearly illustrates a situation wherein a rendering (or presentation) capability has been taken into account and influences the streaming bit-rate to be chosen. Examples of rendering devices that may require, relatively speaking, a reduced streaming bit-rate are:

a wireless PDA or videophone with only a black and white display,

a wireless lower end speaker,

Another factor of the destination that may influence the streaming bit rate is, e.g., a processing capability of the destination. For example, a wireless music stream device that comprises an MP3 and an MP3-Pro decoding capability may be served with a stream that requires a lower bit-rate when an MP3-Pro song is streamed. This compared to a similar device that merely provides an MP3 decoding capability.

Yet another factor of the destination that may influence the streaming bit rate is, e.g., a storage or buffering capability of the destination. For example, it may be the case that the guaranteed streaming bit-rate turns out to be rather low due to a rather poor buffering capability at the destination. In contrast a destination that comprises a large buffering capability may very well be used to smoothen a variation in the guaranteed streaming bit rate. This is possible since, e.g., the guaranteed streaming bit-rate may change over time. In this case it may be better to talk about an average guaranteed streaming bit-rate. In another example the streaming bit-rate may only drop for a relative short period, e.g., due to a person walking by who is temporarily blocking a the transmission path. In an event that the destination device only comprises a small buffering capability it may very well cause a run-out of the buffer. This will typically result in an unacceptable disruption (of, e.g., a 160 Kbps MP3 audio that is being streamed). By choosing a lower transmission bit-rate the run-out may in turn be prevented (at the cost of an average lower quality of, e.g., an 80 Kbps MP3 audio that is being streamed).

A user profile is another factor that the invention enables to be taken into account when choosing an adequate streaming bit-rate when streaming the content. For instance a high fidelity enthusiastic will typically require a high quality when watching a certain movie in contrast to his child who may be happy watching the same movie at a much lower quality and thus lower streaming bit-rate. Obviously this applies to both wired as well as wireless networks.

A control device may control the transport of content, related functions and other measures as described in the invention. The control device can be embedded in transmitter 200 and/or receiver 210 but can be located elsewhere (whereby, e.g., transmitter 200 and receiver are part of a larger distributed system).

A software application (SW) may enable the transport of the content that is streamed via the data network. The SW and its modules may also enable other related functions and other measures as described in the invention

The combination of transmitter 200 and receiver 210 may in turn be part of a bigger part of an end-to-end content delivery chain and system. Such a system is described in the next paragraphs.

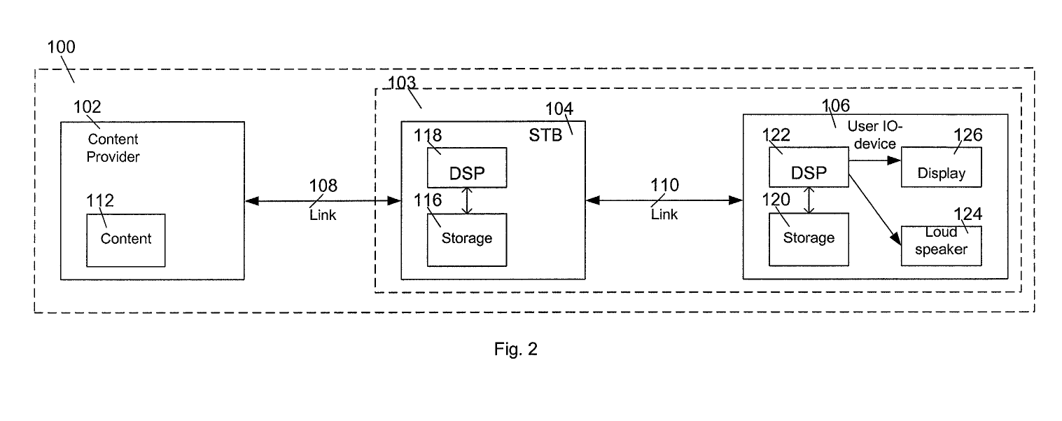

FIG. 2 is a functional block-diagram of an end-to-end content delivery system 100 of the invention. System 100 comprises a service/content provider 102, a gateway STB 104, a user IO device 106, a link 108 between provider 102 and STB 104 and a link 110 between STB 104 and device 106.

Provider 102 supplies content 112 via a connection to link 108. Provider 102 is for example a broadband cable operator, a Direct To Home (DTH) satellite operator or an Internet Service Provider (ISP). Examples of the content 112 are a pay-per-view (ppv) movie or a live television broadcast. Examples of link 108 are a cable-network, a POTS telephone/xDSL line, a wireless link between a DTH satellite and a parabolic antenna for satellite reception with a POTS line as a return link.

STB 104 comprises a DSP 118, storage 116 and a connection to link 110. An example of STB 104 are a consumer digital cable box with PTV functionality or a home gateway-server. An example of DSP 118 is a VLIW based AV-processor (such as a Trimedia processor), which is capable of performing tasks such as transport stream de-multiplexing (TS-demux) and MPEG2 encoding or transcoding. Examples of storage 116 are a HDD, a DVD+RW and a Flash memory. Examples of link 110 are a wired IHDN such as based on IEEE1394, USB, HPNA, Ethernet, etc., or a wireless IHDN such as based on Home-RF, 802.11b or Bluetooth.

Device 106 comprises a DSP 122, a storage 120, a display monitor 126 and a loudspeaker 124. An example of device 106 is an HDTV display connected to IEEE1394 as an example of link 110. An example of DSP 122 is another VLIW based AV-processor, which is capable of performing tasks such as MPEG2 decoding in combination with AV (Audio and/or Video) restoration or enhancement. An example of storage 120 is an SDRAM. Examples of display 126 are a 60″ CRT-based rear projection TV, a 46″ Plasma display and a 10″ LCD based portable WIA (such as a WebPad). Examples of loudspeaker 124 are a low-end 2×5-Watt amplifier speaker system or a high-end 5×-100-Watt surround sound amplifier speaker system.

STB 104 and device 106 typically, but not exclusively, reside at the end user's premises. STB 104 can be located in a metering cabinet and device 106 in a user's living room. In that case a UI is presented using device 106. STB 104 and device 106 can also physically be combined into a combination device 103 or its components can also be distributed for, e.g., cost or convenience reasons. For instance when STB 104 and device 106 are combined into combination device 103 link 110 can become a cheaper internal link and DSP 118 and DSP 122 can become one, integrally, cheaper DSP.

Depending on an end-user profile, end-user settings and on the type of display 126 the processing in DSP 122 can be adapted to provide an optimum picture quality. Depending on the end-user setting and the type of speaker 124 the processing in 122 can be adapted to provide an optimum sound quality.

Device 106 can inform STB 104, using link 110, of the AV quality and resolution it requires. Device 106 may also include or allocate processing power, e.g., from DSP 122, which can perform sound or picture improvements, e.g., in order to mask artifacts due to a compression algorithm applied. STB 104 in turn can use the information, such as the end-user profile etc., to efficiently store the AV (typically in compressed format) on the storage 116. As a result STB 104 can store more AV or can be equipped with less, typically cheaper, storage in the example wherein it features PTV functionality. Moreover link 110 can be of a lower bandwidth type or can be shared for other purposes simultaneously. STB 104 can use DSP 118 to store the AV more efficiently using techniques such as encoding and transcoding.

Device 104 can forward the information it receives from STB 104 to provider 102 using link 108. Link 108 can have separate download and return paths to provider 102, e.g., a POTS modem as a return path and a satellite link as download path. Such a return path is needed in case the path from provider 102 to STB 104 for sending content does not have return capabilities; e.g. in case of DTH (Direct To Home) satellite transmission. In case provider 102 is capable of sending its content 112 on request (of, e.g., a user, STB 104 or device 106 or any combination), it can send it with a customized bit-rate. In practice this mostly means that it will try to send its content at the lowest bit-rate possible while minimizing user perceived artifacts at the time of presentation. Doing so probably will result in an average lower bandwidth requirement and in lower system and operation costs for system 100.

While the invention has been shown and described with reference to certain preferred embodiments thereof, it will be understood by those skilled in the art that various changes in form and details may be made therein without departing from the spirit and scope of the invention as defined by the appended claims.

Herein incorporated by reference are the following patent documents:

Adrian Turner et al., “Customized upgrading of internet-enabled devices based on user-profile”, Sep. 25, 1998, U.S. application Ser. No. 09/160,490 (attorney docket PHA23,500).

Shteyn, “Upgrading of synergetic aspects of home networks”, Nov. 10, 1998, U.S. application Ser. No. 09/189,535. (attorney docket PHA23,527)

Ekkel et al., “Personalizing CE equipment configuration at server via web-enabled device”, Mar. 6, 2000, U.S. application Ser. No. 09/519,546 (attorney docket US 000014).

What is claimed is:

1. A method of enabling a transport of content that is streamed via a data network, wherein the method comprises the steps of:
monitoring a condition of the data network, and
dynamically influencing a streaming bit-rate depending on the condition.

2. The method of claim 1, for use with a wireless portion of the data network.

3. The method of claim 2, wherein the monitoring comprises at least one of the following steps:
determining a signal-to-noise ratio,
determining an error in the transport, and
determining an availability of a free sub-band in an allocated spectrum.

4. The method of claim 1, comprising dynamically influencing an error-correction process that depends on the condition.

5. The method of claim 1, further comprising influencing the streaming bit-rate, taking into account at least one of the following:
a processing capability of a destination of the content,
a storage capability of the destination, and
a presentation capability of the destination.

6. The method of claim 1, comprising influencing the streaming bit-rate, taking into account a user profile.

7. A software application (SW) for enabling a transport of content that is streamed via a data network, wherein the SW comprises:
a first module for monitoring a condition of the data network, and
a second module for dynamically influencing a streaming bit-rate depending on the condition.

8. The SW of claim 7, for use with a wireless portion of the data network.

9. The SW of claim 8, wherein the first module comprises at least one of the following:
a third module for determining a signal-to-noise ratio,
a fourth module for determining an error in the transport, and
a fifth module for determining an availability of a free sub-band in an allocated spectrum.

10. The SW of claim 7, comprising a sixth module for dynamically influencing an error-correction process that depends on the condition.

11. The SW of claim 7, comprising a seventh module for enabling communication of at least one of the following parameters:
a processing capability of a destination of the content,
a storage capability of the destination, and
a presentation capability of the destination.

12. The SW of claim 7, comprising a eighth module for enabling communication of a user profile.

13. A control device for control of a transport of content that is streamed via a data network, wherein the device comprises:
a first functionality to monitor a condition of the data network, and
a second functionality to influence a streaming bit-rate in a dynamical fashion and depending on the condition.

14. The control device of claim 13, comprising means for controlling a wireless part of the data network.

15. The control device of claim 14, wherein the first functionality includes means for determining at least one of the following:
a signal to noise ratio,
an error in the transport, and
an availability of a free sub-band in an allocated spectrum.

16. The control device of claim 13, comprising means for influencing an error-correction process that depends on the network condition.

17. The control device of claim 13, comprising means for communicating at least one of the following:
a processing capability of a destination of the content,
a storage capability of the destination, and
a presentation capability of the destination.

18. The control device of claim 13, comprising means for communicating a user profile.
